(19) United States
(12) Patent Application Publication
(10) Pub. No.: US 2018/0210170 A1
(43) Pub. Date: Jul. 26, 2018

(54) INFRARED PHOTOGRAPHIC LENS OPTICAL SYSTEM

(71) Applicant: KOLEN CO., LTD., Gyeonggi-do (KR)

(72) Inventors: Jong Jin LEE, Seoul (KR); Chan Goo KANG, Gyeonggi-do (KR); Seong Hee BAE, Gyeonggi-do (KR)

(21) Appl. No.: 15/880,211

(22) Filed: Jan. 25, 2018

(30) Foreign Application Priority Data
Jan. 26, 2017 (KR) 10-2017-0012964

(51) Int. Cl. G02B 9/34; H04N 5/225

(52) U.S. Cl. CPC G02B 9/34; H04N 5/2254; H04N 5/2253

(57) ABSTRACT

Provided is an infrared photographic lens optical system. The infrared photographic lens optical system includes an incident light restricting unit restricting incidence of a light passed through a given lens, an image sensor sensing an image of an object, a lens system including first to fourth lenses arranged sequentially from the object to the image sensor between the object and the image sensor, and a visible light blocking unit arranged between the first lens and the image sensor.

### CROSS-REFERENCE TO RELATED APPLICATION

This application claims the benefit of Korean Patent Application No. 10-2017-0012964, filed on Jan. 26, 2017, in the Korean Intellectual Property Office, the disclosure of which is incorporated herein in its entirety by reference.

### BACKGROUND

### 1. Field

One or more embodiments relate to optical systems including lenses, and more particularly, to infrared photographic lens optical systems used in cameras.

### 2. Description of the Related Art

Recent cameras are mostly digital cameras including an image sensor, a memory, and a lens optical system. Cameras are also used in combination with other electronic devices such as communication devices. A charge coupled device (CCD) and a complementary metal oxide semiconductor image sensor (CMOS) are widely used as an image sensor used in a camera.

The resolution of a camera may also be influenced by a post-processing process of processing a captured image. However, the resolution of a camera is mainly influenced by the pixel integration degree of an image sensor and a lens optical system. As the pixel integration degree of an image sensor becomes higher, a clearer image may be obtained and a more natural image color may be implemented. Also, as the aberration of a lens optical system becomes smaller, a clearer and more accurate image may be obtained.

In order to reduce the aberration, the lens optical system includes one or more lenses. Depending on the camera or the device using the camera, the lens optical system may include a glass lens or may include a plastic lens.

In the case of a camera combined with a mobile, in order to reduce the weight of the camera itself, a recent trend is to substitute plastic lenses for the lenses included in a lens optical system.

### SUMMARY

One or more exemplary embodiments include an infrared photographic lens optical system that is compact and may implement a wide angle while reducing a manufacturing cost.

Additional aspects will be set forth in part in the description which follows and, in part, will be apparent from the description, or may be learned by practice of the presented embodiments.

According to one or more exemplary embodiments, an infrared photographic lens optical system includes: an incident light restricting unit restricting incidence of a light passed through a given lens; an image sensor sensing an image of an object; a lens system including first to fourth lenses arranged sequentially from the object to the image sensor between the object and the image sensor; and a visible light blocking unit arranged between the first lens and the image sensor.

In the infrared photographic lens optical system, the incident light restricting unit may include an iris diaphragm or a light absorbing film. The light absorbing film may be coated on an edge region of the lens arranged after the given lens.

The incident light restricting unit may be arranged between the second lens and the third lens.

The first lens and the second lens may have a negative power, and the third lens and the fourth lens may have a positive power.

One or more of the four lenses may be glass lenses, and the others may be plastic lenses.

The visible light blocking unit may be arranged between the fourth lens and the image sensor. In this case, the visible light blocking unit may be arranged nearer to the fourth lens or may be arranged nearer to the image lens.

An interval between the second lens and the third lens may be largest in the first to fourth lenses.

In the infrared photographic lens optical system, a field of view (FOV) may satisfy the following condition:

120<FOV<140

In the infrared photographic lens optical system, a total track length (TTL) and a diagonal length (ImgH) of an effective pixel region may satisfy the following condition:

2.5<TTL/ImgH<3.5

In the infrared photographic lens optical system, an F-number (F/#) may satisfy the following condition:

2.5<F/#<3.0

In the infrared photographic lens optical system, a ratio (D1/D3) of an outer diameter (D1) of the first lens to an outer diameter (D3) of the third lens may satisfy the following condition:

3.0<D1/D3<4.0

In the infrared photographic lens optical system, a refractive index (Ind1) of the first lens and a refractive index (Ind3) of the third lens may satisfy the following condition:

1.6<(Ind1+Ind3)/2<1.7

In the infrared photographic lens optical system, a total track length (TTL) and a distance (AL) from the incident light restricting unit to the image sensor may satisfy the following condition:

1.5<TTL/AL<2.5

In the infrared photographic lens optical system, a focal length (f3) of the third lens and a focal length (f4) of the fourth lens may satisfy the following condition:

2<f4/f3<5

### BRIEF DESCRIPTION OF THE DRAWINGS

These and/or other aspects will become apparent and more readily appreciated from the following description of the exemplary embodiments, taken in conjunction with the accompanying drawings in which:

FIGS. 1 to 3 are cross-sectional views illustrating first to third infrared photographic lens optical systems according to an exemplary embodiment;

FIGS. 4 to 6 are aberration diagrams illustrating a longitudinal spherical aberration, an astigmatic field curvature, and a distortion of the first infrared photographic lens optical system of FIG. 1;

FIGS. 7 to 9 are aberration diagrams illustrating a longitudinal spherical aberration, an astigmatic field curvature, and a distortion of the second infrared photographic lens optical system of FIG. 2;

FIGS. 10 to 12 are aberration diagrams illustrating a longitudinal spherical aberration, an astigmatic field curvature, and a distortion of the third infrared photographic lens optical system of FIG. 3; and

FIG. 13 is a cross-sectional view illustrating a case where a lens edge surface is coated instead of using an iris diaphragm in the first infrared photographic lens optical system of FIG. 1.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, infrared photographic lens optical systems according to embodiments of the present disclosure will be described in detail with reference to the accompanying drawings. The thicknesses of layers or regions illustrated in the drawings may be somewhat exaggerated for clarity of the specification.

In the following description, a first surface of each lens may represent an incidence surface on which light is incident, and a second surface thereof may represent an exit surface through which the light incident on the first surface exits.

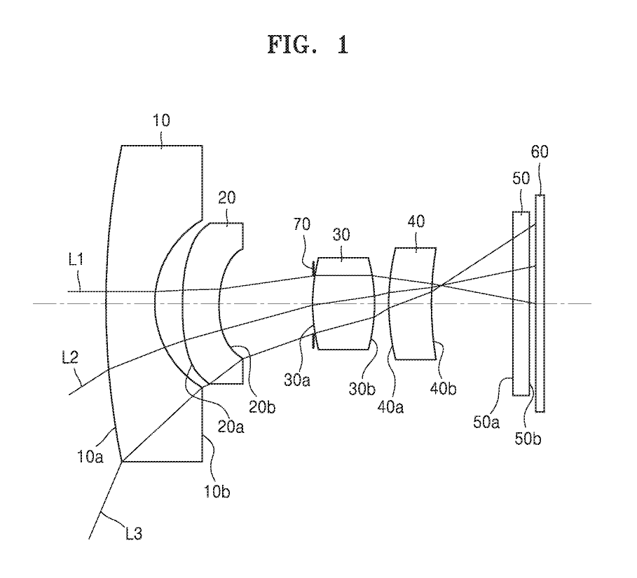

FIG. 1 illustrates an infrared photographic lens optical system according to an exemplary embodiment (hereinafter referred to as a first infrared photographic lens optical system). The infrared photographic lens optical system means a photographic lens optical system that uses infrared in order to form an image.

Referring to FIG. 1, the first infrared photographic lens optical system may include first to fourth lenses 10, 20, 30, and 40 arranged sequentially between an object (not illustrated) and an image sensor 60. The first to fourth lenses 10, 20, 30, and 40 may be collectively referred to as a lens system including four lenses. The object may be located on the left side of the first lens 10 in FIG. 1. One or more of the first to fourth lenses 10, 20, 30, and 40 may be glass lenses, and the others may be plastic lenses. For example, the first, second, and fourth lenses 10, 20, and 40 may be plastic lenses, and the third lens 30 may be a glass lens. The material of one or more of the first, second, and fourth lenses 10, 20, and 40 may be different from the material of the others. For example, the first lens 10 may be a lens of a first plastic material, and the second lens 20 or the second and fourth lenses 20 and 40 may be a plastic lens of a material different from the first plastic material.

The first to fourth lenses 10, 20, 30, and 40 may be arranged sequentially from the object to the image sensor 60. The outer diameters of the lenses may decrease in the order of the first lens 10, the second lens 20, the fourth lens 40, and the third lens 30. Thus, the first infrared photographic lens optical system may be of a convergent shape as a whole. While maintaining this shape, the outer diameter of the second lens 20 may be smaller than the outer diameter of the third lens 30.

Lights L1 to L3 incident on the first lens 10 from the object may reach the image sensor 60 sequentially through the second to fourth lenses 20, 30, and 40. A light blocking unit 50 may be arranged between the fourth lens 40 and the image sensor 60. The light blocking unit 50 may be arranged nearer to the image sensor 60 than to the fourth lens 40. The light blocking unit 50 may be a visible light blocking unit. For example, the visible light blocking unit may be a blocking filter that transmits only infrared rays. The light blocking unit 50 may have first and second surfaces 50a and 50b. An iris diaphragm 70 may be arranged between the second lens 20 and the third lens 30. The iris diaphragm 70 may be arranged near a first surface 30a that is a light incidence surface of the third lens 30. The amount of light incident on the third lens 30 may be adjusted by the iris diaphragm 70. The iris diaphragm 70 may be arranged apart from the first surface 30a of the third lens 30 or may contact the first surface 30a. The iris diaphragm 70 may contact an edge region of the first surface 30a of the third lens 30. The position of the iris diaphragm 70 may be adjusted between the second lens 20 and the third lens 30. The image sensor 60 and the light blocking unit 50 may be parallel to each other. The iris diaphragm 70, the first to fourth lenses 10, 20, 30, and 40, and the light blocking unit 50 may be aligned on the same optical axis (one-dot chain line). The image sensor 60 may also be aligned on the optical axis.

The first lens 10 may have a negative power, that is, a negative refractive power. A first surface 10a of the first lens 10 may be a curved surface convex toward the object side. The first surface 10a may be a spherical surface. A second surface 10b of the first lens 10 may also be convex toward the object side. The second surface 10b may be a curved surface having a smaller curvature radius than the first surface 10a and may be an aspherical surface.

The second lens 20 located on the right side of the first lens 10 may have a negative power. A first surface 20a of the second lens 20 may be a curved surface and may be an aspherical surface. The curvature radius of the first surface 20a may be larger than the curvature radius of a second surface 20b. The first surface 20a of the second lens 20 may be convex toward the object side. The second surface 20b of the second lens 20 may be a curved surface and may be an aspherical surface. The second surface 20b may be a curved surface convex toward the object side.

The third lens 30 may have a positive power, that is, a positive refractive power. The third lens 30 may be a biconvex lens. That is, the first surface 30a of the third lens 30 may be convex toward the object side, and a second surface 30b thereof may be a curved surface convex toward the image sensor 60. The first and second surfaces 30a and 30b of the third lens 30 may be spherical surfaces.

The fourth lens 40 may have a positive power. The fourth lens 40 may be convex toward the object side as a whole. That is, first and second surfaces 40a and 40b of the fourth lens 40 may be curved surfaces convex toward the object side. The curvatures of the first and second surfaces 40a and 40b of the fourth lens 40 may be different from each other. The first and second surfaces 40a and 40b of the fourth lens 40 may be aspherical surfaces.

The second surface 10b as a light emission surface of the first lens 10, both surfaces 20a and 20b of the second lens 20, and both surfaces 40a and 40b of the fourth lens 40 may all be aspherical surfaces.

The overall focal length and performance of the first infrared photographic lens optical system of FIG. 1 may vary according to the thicknesses, focal lengths, and/or arrangement intervals of the first to fourth lenses 10, 20, 30, and 40.

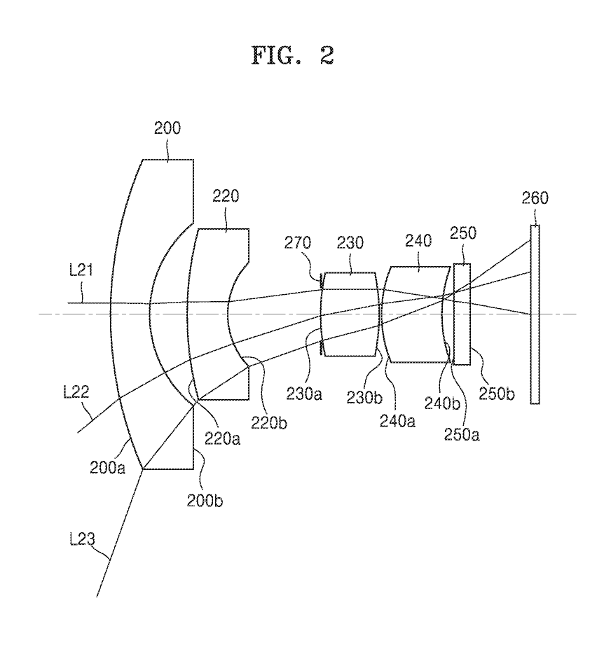

FIG. 2 illustrates an infrared photographic lens optical system according to another exemplary embodiment (hereinafter referred to as a second infrared photographic lens optical system).

Referring to FIG. 2, like the first infrared photographic lens optical system of FIG. 1, the second infrared photographic lens optical system may include four lenses including spherical surfaces and aspherical surfaces, that is, first to fourth lenses 200, 220, 230, and 240, a light blocking unit 250, an image sensor 260, and an iris diaphragm 270.

The curved surface shapes and the mutual curvature radius relationships of both surfaces 200a and 200b of the first lens 200, both surfaces 220a and 220b of the second lens 220, both surfaces 230a and 230b of the third lens 230, and both surfaces 240a and 240b of the fourth lens 240 may correspond to those of both surfaces of the first to fourth lenses 10, 20, 30, and 40 of the first infrared photographic lens optical system of FIG. 1. The functions of the iris diaphragm 270, the light blocking unit 250, and the image sensor 260 of the second infrared photographic lens optical system may also correspond to the functions of the iris diaphragm 70, the light blocking unit 50, and the image sensor 60 of the first infrared photographic lens optical system of FIG. 1. In FIG. 2, the light blocking unit 250 may be located nearer to the fourth lens 240 than to the image sensor 260.

The overall configuration and arrangement relationship of the first to fourth lenses 200, 220, 230, and 240 of the second infrared photographic lens optical system of FIG. 2 may be the same as or similar to the overall configuration and arrangement relationship of the first to fourth lenses 10, 20, 30, and 40 of the first infrared photographic lens optical system of FIG. 1.

However, the optical characteristics (e.g., refractive indexes, curvature radiuses, Abbe numbers, and aspherical surface coefficients) of the lenses between the first infrared photographic lens optical system of FIG. 1 and the second infrared photographic lens optical system of FIG. 2 may be slightly different from each other, as may be seen from the following tables and aberration diagrams.

In FIG. 2, reference numerals L21, L22, and L23 denote the lights incident on the first lens 200 from the object.

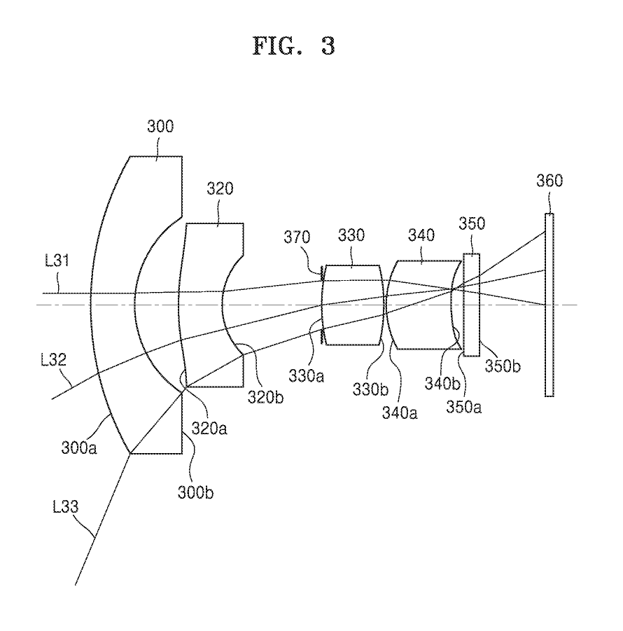

FIG. 3 illustrates an infrared photographic lens optical system according to another exemplary embodiment (hereinafter referred to as a third infrared photographic lens optical system).

Referring to FIG. 3, the third infrared photographic lens optical system may include four lenses including first to fourth lenses 300, 320, 330, and 340. The materials and configurations of the first to fourth lenses 300, 320, 330, and 340 may be the same as or similar to those of the first to fourth lenses 10, 20, 30, and 40 of the first infrared photographic lens optical system of FIG. 1. The third infrared photographic lens optical system may further include an iris diaphragm 370, a light blocking unit 350, and an image sensor 360.

Both surfaces 300a and 300b of the first lens 300, both surfaces 320a and 320b of the second lens 320, both surfaces 330a and 330b of the third lens 330, and both surfaces 340a and 340b of the fourth lens 340 may correspond to both surfaces of the first to fourth lenses 200, 220, 230, and 240 of the second infrared photographic lens optical system of FIG. 2. Also, the iris diaphragm 370, the light blocking unit 350, and the image sensor 360 of the third infrared photographic lens optical system may also correspond to the iris diaphragm 270, the light blocking unit 250, and the image sensor 260 of the second infrared photographic lens optical system of FIG. 2.

The overall configuration and arrangement relationship of the first to fourth lenses 300, 320, 330, and 340 of the third infrared photographic lens optical system may be the same or similar to the overall configuration and arrangement relationship of the first to fourth lenses 200, 220, 230, and 240 of the second infrared photographic lens optical system of FIG. 2.

However, the optical characteristics (e.g., refractive indexes, curvature radiuses, Abbe numbers, and aspherical surface coefficients) of the lenses between the third infrared photographic lens optical system of FIG. 3 and the first and second infrared photographic lens optical systems of FIGS. 1 and 2 may be slightly different from each other, as may be seen from the following tables and aberration diagrams.

In FIG. 3, reference numerals L31, L32, and L33 denote the lights incident on the first lens 300 from the object.

Next, the optical characteristics of the respective elements of the first to third infrared photographic lens optical systems illustrated in FIGS. 1 to 3 will be described in detail.

Table 1 below illustrates the curvature radiuses (R), the lens thicknesses or the distances between the lenses or the distances (T) between the adjacent elements, the refractive indexes (Nd), and the Abbe numbers (Vd) of the members (10, 20, 30, 40, 50, 60, and 70) included in the first infrared photographic lens optical system. The refractive index (Nd) may represent the refractive index of each lens measured by using a d-line. Also, the Abbe number (Vd) may represent the Abbe number of the lens with respect to the d-line. In the number of a lens surface, “*” may indicate that the lens surface is an aspherical surface. Also, the unit of “R” value and “T” value may be mm.

TABLE 1

| Component | Surface | R | T | Nd | Vd |
|---|---|---|---|---|---|
| First Lens 10 | 10a | 28.8069 | 1.8855 | 1.619 | 23.265 |
| | 10b* | 3.6114 | 1.0733 | | |
| Second Lens 20 | 20a* | 11.3841 | 1.4183 | 1.619 | 23.265 |
| | 20b* | 4.1854 | 3.6501 | | |
| Iris Diaphragm 70 | 70 | infinity | −0.0100 | | |
| Third Lens 30 | 30a | 6.3524 | 2.3678 | 1.760 | 49.624 |
| | 30b | −6.3524 | 0.5731 | | |
| Fourth Lens 40 | 40a* | 7.2997 | 1.6610 | 1.527 | 55.656 |
| | 40b* | 26.7750 | 3.9808 | | |
| Light Blocking Unit 50 | 50a | Infinity | 0.3000 | | |
| | 50b | Infinity | 0.1065 | | |
| Image Sensor 60 | IMG | Infinity | −0.0074 | | |

The aspherical surface of the lens included in the first infrared photographic lens optical system of FIG. 1 may satisfy an aspherical surface equation of Condition 1 below.

$$Z = \frac{{Y}^{2}}{R ( 1 + \sqrt{1 - ( 1 + K ) {Y}^{2} / {R}^{2}}} + {AY}^{4} + {BY}^{6} + {CY}^{8} + {DY}^{10} + {EY}^{12} + {FY}^{14} + {GY}^{16} + {HY}^{18} + {JY}^{20}$$

In Condition 1, “Z” denotes the distance from the apex of each lens in the optical axis direction, “Y” denotes the distance in the direction perpendicular to the optical axis, “R” denotes the curvature radius, “K” denotes a conic constant, and “A”, “B”, “C”, “D”, “E”, “F”, “G”, “H”, and “J” denote aspherical coefficients.

Table 2 below illustrates the aspherical coefficients of each surface of the first, second, and fourth lenses 10, 20, and 40 having aspherical surfaces, which are included in the first infrared photographic lens optical system of FIG. 1.

TABLE 2

| Surface | K | A | B | C | D | E |
|---|---|---|---|---|---|---|
| 10b* | 0.2091 | −0.0015 | −2.0363e−005 | −3.9036e−005 | 2.0982e−006 | −4.1365e−008 |
| 20a* | 0.0000 | 0.0067 | −6.9305e−005 | 2.1389e−005 | 1.7511e−006 | 0.0000 |
| 20b* | −0.4429 | 0.0171 | 0.0017 | −0.0002 | 0.0001 | 0.0000 |
| 40a* | 2.4744 | −7.1874e−005 | −0.0009 | 8.6692e−005 | −1.3656e−005 | 0.0000 |
| 40b* | 0.0000 | 0.0085 | −0.0004 | −1.9980e−005 | 5.7347e−007 | 0.0000 |

| Surface | F | G | H | J |
|---|---|---|---|---|
| 10b* | 0.0000 | 0.0000 | 0.0000 | 0.0000 |
| 20a* | 0.0000 | 0.0000 | 0.0000 | 0.0000 |
| 20b* | 0.0000 | 0.0000 | 0.0000 | 0.0000 |
| 40a* | 0.0000 | 0.0000 | 0.0000 | 0.0000 |
| 40b* | 0.0000 | 0.0000 | 0.0000 | 0.0000 |

When the elements included in the first infrared photographic lens optical system of FIG. 1 have the optical characteristics as illustrated in Tables 1 and 2, the F-number of the first infrared photographic lens optical system is about 2.8 and the focal length (f) is about 2.7059 mm.

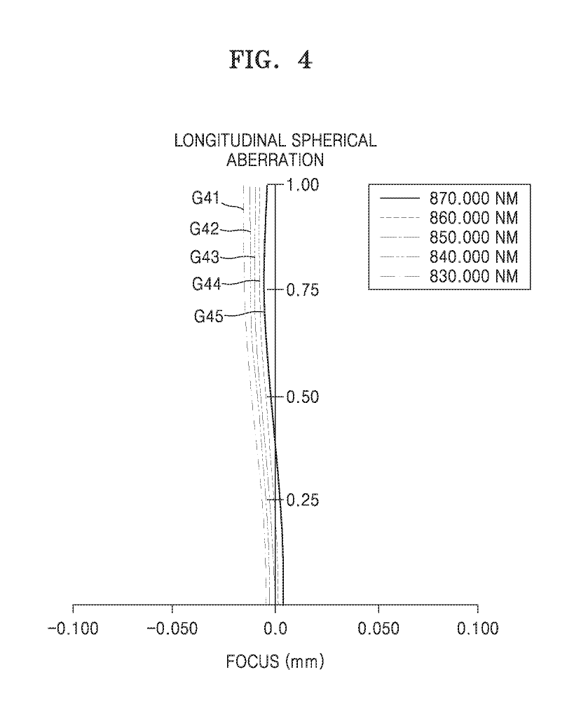

FIG. 4 illustrates a longitudinal spherical aberration of the first infrared photographic lens optical system when the lenses included in the first infrared photographic lens optical system of FIG. 1 have aspherical coefficients and dimensions according to Tables 1 and 2.

In FIG. 4, a first graph G41 represents the result when the wavelength of the incident light is 830.0000 nm, and a second graph G42 represents the result when the wavelength of the incident light is 840.0000 nm. A third graph G43 represents the result when the wavelength of the incident light is 850.0000 nm, and a fourth graph G44 represents the result when the wavelength of the incident light is 860.0000 nm. Also, a fifth graph G45 represents the result when the wavelength of the incident light is 870.0000 nm.

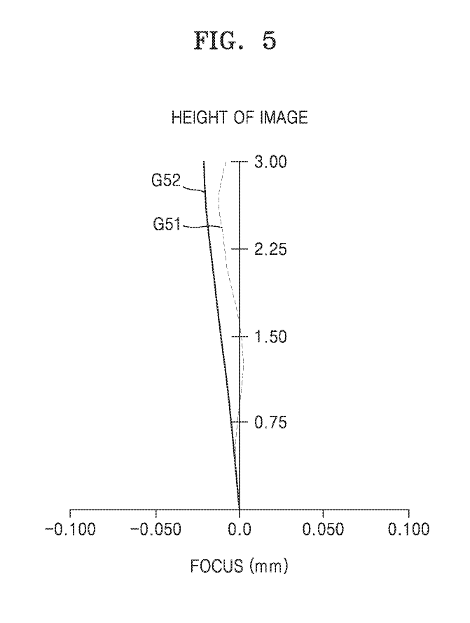

FIG. 5 illustrates an astigmatic field curvature of the first infrared photographic lens optical system when the lenses included in the first infrared photographic lens optical system of FIG. 1 have aspherical coefficients and dimensions according to Tables 1 and 2. The results of FIG. 5 are obtained by using light with a wavelength of 850.0000 nm.

In FIG. 5, a first graph G51 represents a tangential field curvature, and a second graph G52 represents a sagittal field curvature.

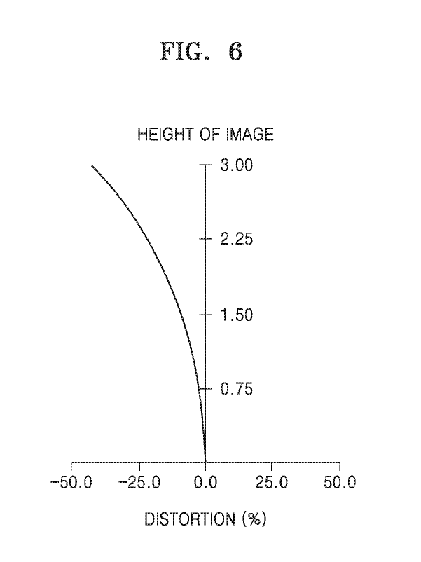

FIG. 6 illustrates a distortion of the first infrared photographic lens optical system when the lenses included in the first infrared photographic lens optical system of FIG. 1 have aspherical coefficients and dimensions according to Tables 1 and 2. The results of FIG. 6 are obtained by using light with a wavelength of 850.0000 nm.

Table 3 below illustrates the curvature radiuses (R), the lens thicknesses or the distances between the lenses or the distances (T) between the adjacent elements, the refractive indexes (Nd), and the Abbe numbers (Vd) of the members (200, 220, 230, 240, 250, 260, and 270) included in the second infrared photographic lens optical system. The refractive index (Nd) may represent the refractive index of each lens measured by using a d-line. Also, the Abbe number (Vd) may represent the Abbe number of the lens with respect to the d-line. In the number of a lens surface, “*” may indicate that the lens surface is an aspherical surface. Also, the unit of “R” value and “T” value may be mm.

TABLE 3

| Component | Surface | R | T | Nd | Vd |
|---|---|---|---|---|---|
| First Lens 200 | 200a | 14.9512 | 1.7000 | 1.619 | 23.265 |
| | 200b* | 4.3299 | 1.6019 | | |
| Second Lens 220 | 220a* | 8.5992 | 1.7000 | 1.619 | 23.265 |
| | 220b* | 3.1717 | 4.0149 | | |
| Iris Diaphragm 270 | 270 | infinity | −0.0100 | | |
| Third Lens 230 | 230a | 7.2719 | 2.5016 | 1.760 | 49.624 |
| | 230b | −7.2719 | 0.1000 | | |
| Fourth Lens 240 | 240a* | 4.6002 | 2.5803 | 1.527 | 55.656 |
| | 240b* | 9.1603 | 0.5000 | | |
| Light Blocking Unit 250 | 250a | Infinity | 0.3000 | | |
| | 250b | Infinity | 3.0204 | | |
| Image Sensor 260 | IMG | Infinity | −0.0091 | | |

The aspherical surface of the lens included in the second infrared photographic lens optical system of FIG. 2 may satisfy the aspherical surface equation of Condition 1.

Table 4 below illustrates the aspherical coefficients of the first, second, and fourth lenses 200, 220, and 240 included in the second infrared photographic lens optical system of FIG. 2.

TABLE 4

| Surface | K | A | B | C | D | E |
|---|---|---|---|---|---|---|
| 200b* | −0.0731 | −0.0002 | −3.0384e−005 | −4.4436e−006 | −4.4436e−006 | 4.1177e−007 |
| 220a* | 0.0000 | −0.0008 | −0.0002 | 1.6831e−005 | −4.2695e−007 | 0.0000 |
| 220b* | −2.0860 | 0.0114 | 0.0004 | −9.2934e−005 | 3.9439e−005 | 0.0000 |
| 240a* | 2.1687 | −0.0021 | −0.0006 | 4.7979e−005 | −1.6850e−005 | 0.0000 |
| 240b* | 0.0000 | 0.0106 | 6.1246e−007 | 4.5060e−005 | −6.2250e−006 | 0.0000 |

| Surface | F | G | H | J |
|---|---|---|---|---|
| 200b* | −1.5408e−008 | 0.0000 | 0.0000 | 0.0000 |
| 220a* | 0.0000 | 0.0000 | 0.0000 | 0.0000 |
| 220b* | 0.0000 | 0.0000 | 0.0000 | 0.0000 |
| 240a* | 0.0000 | 0.0000 | 0.0000 | 0.0000 |
| 240b* | 0.0000 | 0.0000 | 0.0000 | 0.0000 |

When the elements included in the second infrared photographic lens optical system of FIG. 2 have the optical characteristics as illustrated in Tables 3 and 4, the F-number of the second infrared photographic lens optical system of FIG. 2 is about 2.8 and the focal length (f) is about 2.7816 mm.

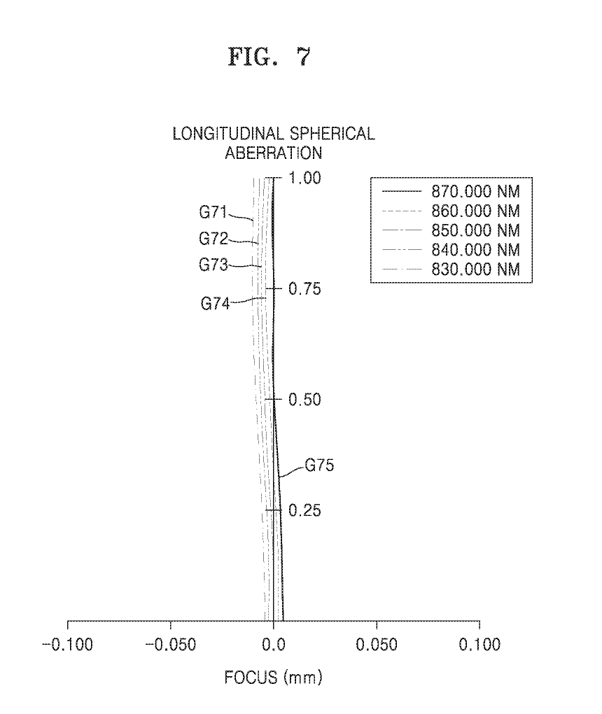

FIG. 7 illustrates a longitudinal spherical aberration of the second infrared photographic lens optical system of FIG. 2 when the lenses included in the second infrared photographic lens optical system of FIG. 2 have aspherical coefficients and dimensions according to Tables 3 and 4.

In FIG. 7, a first graph G71 represents the result when the wavelength of the incident light is 830.0000 nm, and a second graph G72 represents the result when the wavelength of the incident light is 840.0000 nm. A third graph G73 represents the result when the wavelength of the incident light is 850.0000 nm, and a fourth graph G74 represents the result when the wavelength of the incident light is 860.0000 nm. A fifth graph G75 represents the result when the wavelength of the incident light is 870.0000 nm.

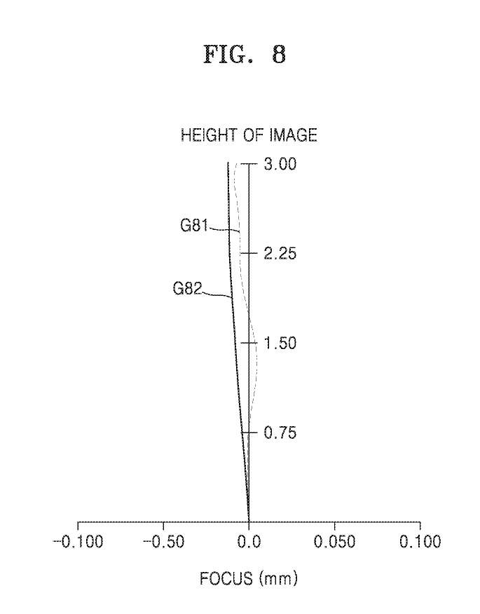

FIG. 8 illustrates an astigmatic field curvature of the second infrared photographic lens optical system of FIG. 2 when the lenses included in the second infrared photographic lens optical system of FIG. 2 have aspherical coefficients and dimensions according to Tables 3 and 4. The results of FIG. 8 are obtained by using light with a wavelength of 850.0000 nm.

In FIG. 8, a first graph G81 represents a tangential field curvature, and a second graph G82 represents a sagittal field curvature.

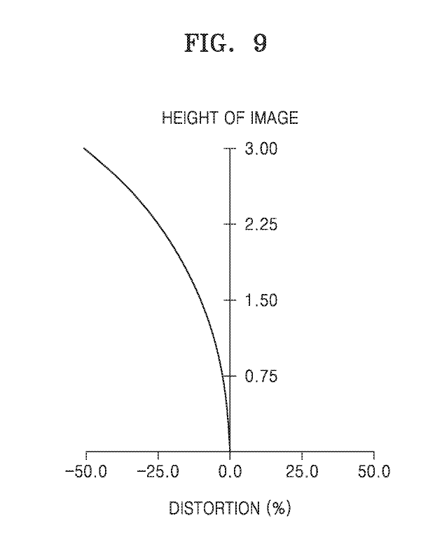

FIG. 9 illustrates a distortion of the second infrared photographic lens optical system of FIG. 2 when the lenses included in the second infrared photographic lens optical system of FIG. 2 have aspherical coefficients and dimensions according to Tables 3 and 4. The results of FIG. 9 are obtained by using light with a wavelength of 850.0000 nm.

Table 5 below illustrates the curvature radiuses (R), the lens thicknesses or the distances between the lenses or the distances (T) between the adjacent elements, the refractive indexes (Nd), and the Abbe numbers (Vd) of the members (300, 320, 330, 340, 350, 360, and 370) included in the third infrared photographic lens optical system of FIG. 3. The refractive index (Nd) may represent the refractive index of each lens measured by using a d-line. Also, the Abbe number (Vd) may represent the Abbe number of the lens with respect to the d-line. In the number of a lens surface, “*” may indicate that the lens surface is an aspherical surface. Also, the unit of “R” value and “T” value may be mm.

TABLE 5

| Component | Surface | R | T | Nd | Vd |
|---|---|---|---|---|---|
| First Lens 300 | 300a | 13.6857 | 1.7000 | 1.619 | 23.265 |
| | 300b* | 4.3161 | 1.7587 | | |
| Second Lens 320 | 320a* | 10.4393 | 1.7000 | 1.619 | 23.265 |
| | 320b* | 3.4376 | 3.9628 | | |
| Iris Diaphragm 370 | 370 | infinity | −0.0100 | | |
| Third Lens 330 | 330a | 7.4406 | 2.4717 | 1.760 | 49.624 |
| | 330b | −7.4406 | 0.1000 | | |
| Fourth Lens 340 | 340a* | 4.2329 | 2.5643 | 1.527 | 55.656 |
| | 340b* | 7.7684 | 0.5000 | | |
| Light Blocking Unit 350 | 350a | Infinity | 0.3000 | | |
| | 350b | Infinity | 2.9617 | | |
| Image Sensor 360 | IMG | Infinity | −0.0091 | | |

The aspherical surface of the lens included in the third infrared photographic lens optical system of FIG. 3 may also satisfy the aspherical surface equation of Condition 1.

Table 6 below illustrates the aspherical coefficients of the first, second, and fourth lenses 300, 320, and 340 included in the third infrared photographic lens optical system of FIG. 3.

TABLE 6

| Surface | K | A | B | C | D | E |
|---|---|---|---|---|---|---|
| 300b* | −0.2044 | 0.0002 | −4.8565e−005 | 3.3468e−007 | 8.2960e−008 | −3.9716e−009 |
| 320a* | 0.0000 | −0.0013 | −0.0002 | 1.9268e−005 | −5.2504e−007 | 0.0000 |
| 320b* | −2.5022 | 0.0101 | 0.0005 | −0.0001 | 4.4312e−005 | 0.0000 |
| 340a* | 1.7478 | −0.0019 | −0.0006 | 3.8093e−005 | −1.7505e−005 | 0.0000 |
| 340b* | 0.0000 | 0.0118 | 0.0002 | 5.3972e−005 | −6.1542e−006 | 0.0000 |

| Surface | F | G | H | J |
|---|---|---|---|---|
| 300b* | 0.0000 | 0.0000 | 0.0000 | 0.0000 |
| 320a* | 0.0000 | 0.0000 | 0.0000 | 0.0000 |
| 320b* | 0.0000 | 0.0000 | 0.0000 | 0.0000 |
| 340a* | 0.0000 | 0.0000 | 0.0000 | 0.0000 |
| 340b* | 0.0030 | 0.0000 | 0.0030 | 0.0000 |

When the elements included in the third infrared photographic lens optical system of FIG. 3 have the optical characteristics as illustrated in Tables 5 and 6, the F-number of the third infrared photographic lens optical system of FIG. 3 is about 2.8 and the focal length (f) is about 2.7919 mm.

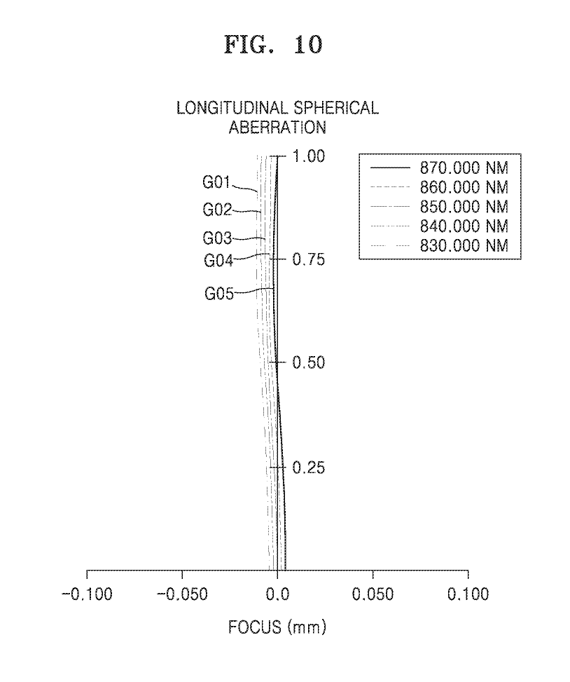

FIG. 10 illustrates a longitudinal spherical aberration of the third infrared photographic lens optical system of FIG. 3 when the lenses included in the third infrared photographic lens optical system of FIG. 3 have aspherical coefficients and dimensions according to Tables 5 and 6.

In FIG. 10, a first graph G01 represents the result when the wavelength of the incident light is 830.0000 nm, and a second graph G02 represents the result when the wavelength of the incident light is 840.0000 nm. A third graph G03 represents the result when the wavelength of the incident light is 850.0000 nm, and a fourth graph G04 represents the result when the wavelength of the incident light is 860.0000 nm. A fifth graph G05 represents the result when the wavelength of the incident light is 870.0000 nm.

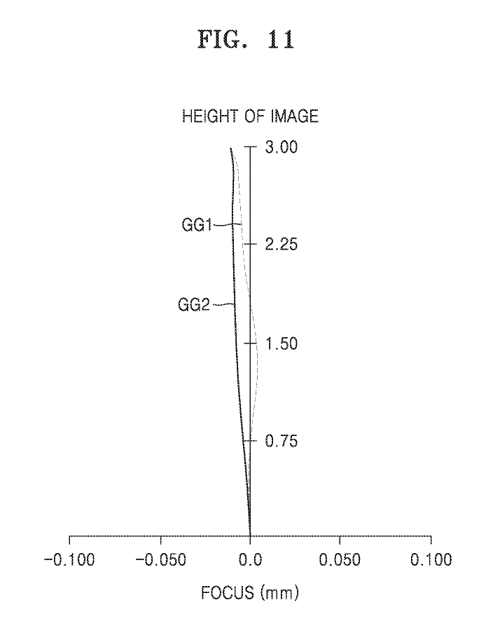

FIG. 11 illustrates an astigmatic field curvature of the third infrared photographic lens optical system of FIG. 3 when the lenses included in the third infrared photographic lens optical system of FIG. 3 have aspherical coefficients and dimensions according to Tables 5 and 6. The results of FIG. 11 are obtained by using light with a wavelength of 850.0000 nm.

In FIG. 11, a first graph GG1 represents a tangential field curvature, and a second graph GG2 represents a sagittal field curvature.

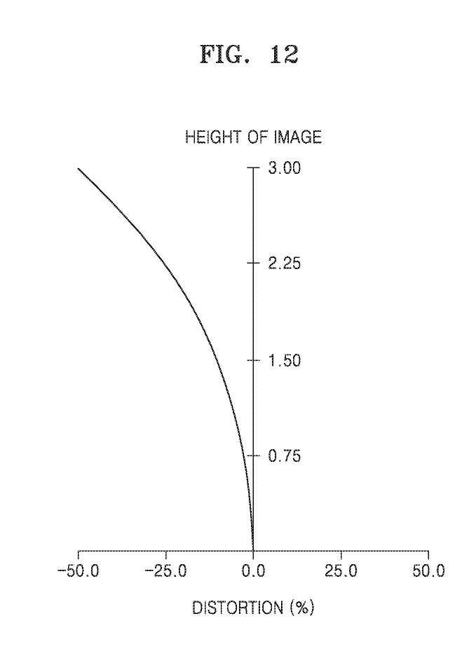

FIG. 12 illustrates a distortion of the third infrared photographic lens optical system of FIG. 3 when the lenses included in the third infrared photographic lens optical system of FIG. 3 have aspherical coefficients and dimensions according to Tables 5 and 6. The results of FIG. 12 are obtained by using light with a wavelength of 850.0000 nm.

The first to third infrared photographic lens optical systems of FIGS. 1 to 3 may satisfy at least one of Conditions 2 to 8 below.

120<FOV<140 Condition 2

In Condition 2, “FOV” denotes an effective field of view of the infrared photographic lens optical system.

When the infrared photographic lens optical system satisfies Condition 2, it may have a wide-angle lens function having a wide field of view.

2.5<TTL/ImgH<3.5 Condition 3

In Condition 3, “TTL” denotes the distance between the image sensor 60 and the center of the first surface 10a of the first lens 10 measured along the optical axis, for example, in the first infrared photographic lens optical system. “ImgH” denotes the diagonal length of an effective pixel region. Condition 3 defines the ratio of the total track length of the infrared photographic lens optical system to the image size. Also, Condition 3 represents the relationship between the correction of the aberration and the size of the infrared photographic lens optical system. Herein, as the value of TTL/ImgH approaches the minimum value, the infrared photographic lens optical system may become slimmer but the aberration correction may be inefficient. On the other hand, as the value of TTL/ImgH approaches the maximum value, the aberration correction may be efficient but the reduction of the size of the infrared photographic lens optical system may be inefficient.

Thus, as the infrared photographic lens optical systems according to exemplary embodiments reach the minimum value of the range of Condition 3, it may be easy to manufacture a compact optical system but it may be difficult to implement the performance. On the other hand, as the infrared photographic lens optical systems according to exemplary embodiments reach the maximum value of the range of Condition 3, it may be easy to implement the performance but it may be difficult to manufacture a compact lens optical system.

2.5<F/#<3.0 Condition 4

In Condition 4, “F/#” denotes the F-number of the infrared photographic lens optical system. Condition 4 defines the F-number of the infrared photographic lens optical system and represents the brightness of the infrared photographic lens optical system. When the infrared photographic lens optical system satisfies Condition 4, a relatively bright image may be implemented.

3.0<D1/D3<4.0 Condition 5

Condition 5 defines the ratio (D1/D3) between the outer diameter D1 of the first lens 10 and the outer diameter D3 of the third lens 30 in each infrared photographic lens optical system, for example, the first infrared photographic lens optical system, and represents the infrared photographic lens optical system in which the outer diameter of the first lens 10 is the largest and the outer diameter of the third lens 30 is the smallest.

1.6<(Ind1+Ind3)/2<1.7 Condition 6

In Condition 6, “Ind1” denotes the refractive index of the first lens 10, 200, or 300 of the first to third infrared photographic lens optical systems. Also, “Ind3” denotes the refractive index of the third lens 30, 230, or 330. Condition 6 defines the refractive indexes of the first lenses 10, 200, and 300 and the third lenses 30, 230, and 330 of the first to third infrared photographic lens optical systems. The effect of reducing the manufacturing cost may be obtained by simultaneously applying glass and plastic as the lens material.

1.5<TTL/AL<2.5 Condition 7

In Condition 7, “AL” denotes the distance from the iris diaphragm 70, 270, or 370 to the image plane on the optical axis. Condition 7 represents the distance from the iris diaphragm to the image plane with respect to the total length of the infrared photographic lens optical system, and the positions of the iris diaphragms 70, 270, and 370 may be defined to satisfy this range.

Condition 8

2<f4/f3<5

In Condition 8, “f3” denotes the focal length of the third lens 30, 230 or 330, and “f4” denotes the focal length of the fourth lens 40, 240, or 340. Condition 8 defines the ratio of the focal length of the third lens 30, 230, or 330 to the focal length of the fourth lens 40, 240, or 340, and it may be possible to implement an infrared photographic lens optical system capable of easily aberration control by maximizing the power of the third lens 30, 230, or 330.

Table 7 below illustrates the values of Conditions 2 to 8 for the first to third infrared photographic lens optical systems of FIGS. 1 to 3.

In Table 7, “First Optical System”, “Second Optical System”, and “Third Optical System” respectively denote the above “first infrared photographic lens optical system”, “second infrared photographic lens optical system”, and “third infrared photographic lens optical system”.

TABLE 7

| | Value of | Value of | Value of | Value of | Value of | Value of | Value of |
|---|---|---|---|---|---|---|---|
| Classification | Condition 2 | Condition 3 | Condition 4 | Condition 5 | Condition 6 | Condition 7 | Condition 8 |
| First Optical System | 125.00 | 2.83 | 2.80 | 3.42 | 1.69 | 1.89 | 4.07 |
| Second Optical System | 131.11 | 3.00 | 2.80 | 3.66 | 1.69 | 2.00 | 2.86 |
| Third Optical System | 130.73 | 3.00 | 2.80 | 3.66 | 1.69 | 2.03 | 2.69 |

Referring to Table 7, it may be seen that all of the first to third infrared photographic lens optical systems of FIGS. 1 to 3 satisfy Conditions 2 to 8.

On the other hand, in the infrared photographic lens optical system of FIG. 1, a unit for restricting the amount of light incident on the first surface 30a of the third lens 30 may be arranged instead of the iris diaphragm 70.

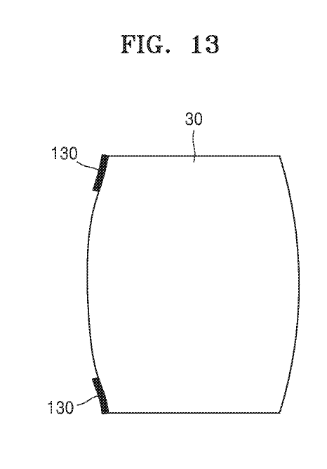

For example, as illustrated in FIG. 13, an incident light amount restricting unit 130 may be provided in an edge region of the first surface 30a of the third lens 30. The incident light amount restricting unit 130 may be, for example, a light absorbing film coated on the edge region. The edge region of the first surface 30a may correspond to a region where light incidence is blocked by the iris diaphragm 70. The iris diaphragm 70 may also be an example of the incident light amount restricting unit. This example of the infrared photographic lens optical system of FIG. 1 may also be applied to the infrared photographic lens optical systems of FIGS. 2 and 3.

The above infrared photographic lens optical systems may be applied to a mobile communication device, and may also be applied to a lens optical system of a photographing device or a recording device for obtaining an image of an object.

Also, the light blocking unit 50, 250, or 350 may be arranged at any position between the first lens 10, 200, or 300 and the image sensor 60, 260, or 360.

In the above infrared photographic lens optical systems, four lenses may be sequentially arranged between the object and the image sensor. In this arrangement, the first lens and the second lens may have a negative power, and the other lenses may have a positive power. One of the four lenses may be a glass lens, and the others may be plastic lenses. Thus, the unit manufacturing cost may be reduced in comparison with the case where all of the four lenses are glass lenses. Also, since the above infrared photographic lens optical systems satisfy Conditions 2 to 8, a compact and wide-angle photographic lens optical system may be implemented.

Although many details have been described above, they are not intended to limit the scope of the present disclosure, but should be interpreted as examples of the exemplary embodiments. Therefore, the scope of the present disclosure should be defined not by the described exemplary embodiments but by the technical spirit described in the following claims.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the disclosure as defined by the following claims.

What is claimed is:

1. An infrared photographic lens optical system comprising:
an incident light restricting unit restricting incidence of a light passed through a given lens;
an image sensor sensing an image of an object;
a lens system comprising first to fourth lenses arranged sequentially from the object to the image sensor between the object and the image sensor; and
a visible light blocking unit arranged between the first lens and the image sensor.

2. The infrared photographic lens optical system of claim 1, wherein the incident light restricting unit comprises an iris diaphragm.

3. The infrared photographic lens optical system of claim 1, wherein the incident light restricting unit comprises a light absorbing film coated on an edge region of the lens arranged after the given lens.

4. The infrared photographic lens optical system of claim 1, wherein the incident light restricting unit is arranged between the second lens and the third lens.

5. The infrared photographic lens optical system of claim 1, wherein the first lens and the second lens have a negative power, and the third lens and the fourth lens have a positive power.

6. The infrared photographic lens optical system of claim 1, wherein one or more of the four lenses are glass lenses, and the others are plastic lenses.

7. The infrared photographic lens optical system of claim 1, wherein the visible light blocking unit is arranged between the fourth lens and the image sensor.

8. The infrared photographic lens optical system of claim 7, wherein the visible light blocking unit is arranged nearer to the fourth lens.

9. The infrared photographic lens optical system of claim 7, wherein the visible light blocking unit is arranged nearer to the image sensor.

10. The infrared photographic lens optical system of claim 1, wherein an interval between the second lens and the third lens is largest in the first to fourth lenses.

11. The infrared photographic lens optical system of claim 1, wherein a field of view (FOV) satisfies the following condition:
120<FOV<140

12. The infrared photographic lens optical system of claim 1, wherein a total track length (TTL) and a diagonal length (ImgH) of an effective pixel region satisfy the following condition:
2.5<TTL/ImgH<3.5

13. The infrared photographic lens optical system of claim 1, wherein an F-number (F/#) satisfies the following condition:
2.5<F/#<3.0

14. The infrared photographic lens optical system of claim 1, wherein a ratio (D1/D3) of an outer diameter (D1) of the first lens to an outer diameter (D3) of the third lens satisfies the following condition:
3.0<D1/D3<4.0

15. The infrared photographic lens optical system of claim 1, wherein a refractive index (Ind1) of the first lens and a refractive index (Ind3) of the third lens satisfy the following condition:
1.6<(Ind1+Ind3)/2<1.7

16. The infrared photographic lens optical system of claim 1, wherein a total track length (TTL) and a distance (AL) from the incident light restricting unit to the image sensor satisfy the following condition:
1.5<TTL/AL<2.5

17. The infrared photographic lens optical system of claim 1, wherein a focal length (f3) of the third lens and a focal length (f4) of the fourth lens satisfy the following condition:
2<f4/f3<5
